(19) United States
(12) Patent Application Publication
(10) Pub. No.: US 2006/0172103 A1
(43) Pub. Date: Aug. 3, 2006

(54) Tape-type magnet

(75) Inventor: Chen-Yang Chang, Kuishan Hsiang (TW)

Correspondence Address: BRUCE H. TROXELL, SUITE 1404, 2505 LEESBURG PIKE, FALLS CHURCH, VA, 22041, US

(73) Assignee: Magruba Flexible Magnets Co., Ltd.

(21) Appl. No.: 11/183,793

(22) Filed: Jul. 19, 2005

(30) Foreign Application Priority Data
Feb. 2, 2005 (CN) 200520004625.1
Jun. 20, 2005 (TW) 94210362

(51) Int. Cl. B32B 33/00

(52) U.S. Cl. 428/40.1; 428/900; 428/43

(57) ABSTRACT

A tape-type magnet including a strap-shaped or tape-shaped soft magnetized substrate. The substrate has a releasing agent layer laid on an outer face of the substrate and an adhesive layer overlaid on an inner face of the substrate. The substrate is wound. At least one end of the wound substrate can be unwound and cut off into a segment. The segment can adhere to a surface of an article. The article with the tape-type magnet call then attract and attach to a magnetically attractable wall face or board face.

### BACKGROUND OF THE INVENTION

The present invention is related to a tape-type magnet, and more particularly to a very thin elongated tape-shaped soft magnetized substrate. Two faces of the substrate respectively have adhesion and magnetic attraction. A segment of the substrate can adhere to a surface of an article. The article with the tape-type magnet can then attract and attach to a magnetically attractable plane face.

A conventional one-face adhesive tape is widely used in daily life. The tape is wound on a reel. In use, an outer end of the tape is drawn out and cut into a segment for attaching to an article.

The above conventional adhesive tape can be improved or modified as necessary. For example, Taiwanese Utility Model Patent Publication No. 500126 discloses an improved double-face adhesive tape.

The tape body of the above double-face adhesive tape is mainly made of soft plastic material such as PVC or EVA. An adhesive layer is coated on bottom face of the tape body. A high-adhesion double-face adhesive membrane is integrally combined with the top face of the tape body. Therefore, both faces of the tape body are adhesive. In addition, a double-face oily releasable paper is attached to back face of the adhesive membrane. Then the tape body is wound on a reel.

The above conventional adhesive tape can be further improved or modified as necessary. For example, a thin soft magnetic strap can be used as a substrate. A releasing agent and an adhesive can be respectively coated on two faces of the substrate. Such adhesive tape has both adhesion and magnetic attraction.

It is hard to manufacture a very thin magnetic material. The thin magnetic material has insufficient strength and tends to break. Therefore, it is quite difficult to wind the thin magnetic material. On the other hand, in the case that the magnetic material is not thin enough, it will be uneasy to cut off the magnetic material and the length of the magnetic material after wound will be limited. Also, in the case that the magnetic material is too thick, the weight of the wound magnetic material per unit length will be too heavy. This makes it difficult to mass-produce, transfer, cut and use the magnetic material. Therefore, it is critical to manufacture the thin magnetic material with a most suitable thickness.

On the other hand, the color of the surface of the conventional soft magnet is black brown due to ferric oxide. For changing the color of the surface of the soft magnet, in a typical method, a color or paint is printed or sprayed on the surface of the soft magnet. However, the molecules of the ferric oxide are much smaller than the molecules of the color or the paint. Therefore, it is hard for the magnetic powder or the saint to attach to the soft magnet. Even if the color successfully attaches to the surface of the soft magnet, when bending the soft magnet such as a magnetic paper clip, crimped decorative sheet and magnetic bookmark, the paint or the magnetic powder is still apt to peel off from the surface of the soft magnet or crack. When using such soft magnet, the peeling magnetic powder or paint will contaminate a user's hand.

Therefore, it is tried by the applicant to provide a tape-type magnet with both adhesion and attraction. In addition, a paint layer can firmly attach to the surface of the magnet without easy peeling.

### SUMMARY OF THE INVENTION

It is therefore a primary object of the present invention to provide a tape-type magnet. Two faces of the tape-type magnet respectively have adhesion and magnetic attraction. A segment of the tape-type magnet can adhere to a surface of an article. The article with the tape-type magnet can then attract and attach to a magnetically attractable wall face or board face.

According to the above object, the tape-type magnet includes a very thin tape-shaped soft magnetized substrate. The substrate has a releasing agent layer laid on an outer face of the substrate and an adhesive layer overlaid on an inner face of the substrate. The substrate is wound. At least ore end of the wound substrate can be unwound and cut off into a segment. The segment can adhere to a surface of an article. The article with the tape-type magnet can then attract and attach to a magnetically attractable wall face or board face.

In order to easily wind, unwind and cut the substrate, the substrate has a thickness within 0.1 mm˜0.4 mm.

In addition, the strap-shaped or tape-shaped soft magnetized substrate is formed with tearing lines for a user to manually tear off a segment of the substrate. Alternatively, at least one side of the substrate is formed with continuous fine teeth, whereby a user can transversely manually tear off a segment of the substrate without using any cutting tool. In contrast, FIG. 7A shows that the conventional tape-type magnet is irregularly manually torn apart.

In addition, a color or paint layer is laid on at least one face of the substrate. The paint layer forms a microcrystalline layer and a crystalline bonding texture is formed between the microcrystalline layer and the substrate. Accordingly, the color or paint layer is antiwear and uneasy to peel off and crack.

The present invention can be best understood through the following description and accompanying drawings wherein:

### BRIEF DESCRIPTION OF THE DRAWINGS

FIG. 1 is a perspective view of the present invention;

FIG. 2 is another perspective view of the present invention;

FIG. 3 is a perspective view showing the application of the present invention to an article;

FIG. 4 is a perspective view according to FIG. 3, showing that the article is fixed on a wall face or board face;

FIG. 5 shows that the substrate of the tape-type magnet of the present invention is formed with tearing lines;

FIG. 6 shows that both sides of the substrate of the tape-type magnet of the present invention are formed with fine teeth;

FIG. 6A is an enlarged view of the circled area A of FIG. 6;

FIG. 7 shows that the substrate of the tape-type magnet of FIG. 6 is manually torn off;

FIG. 7A shows that the conventional tape-type magnet of FIG. 6 is manually torn off;

FIG. 8 shows that the substrate of the tape-type magnet of the present invention is embossed with characters, stripes or figures;

FIG. 9 shows that a spraying apparatus is used to spray the blended paint onto the substrate of the tape-type magnet of the present invention;

FIG. 10 shows that ultraviolet ray is projected onto the paint sprayed on the substrate of the tape-type magnet of the present invention; and

FIG. 11 shows that the microcrystalline gum layer is bonded with the particles of the magnetic layer of the substrate of the tape-type magnet of the present invention.

### DETAILED DESCRIPTION OF THE PREFERRED EMBODIMENTS

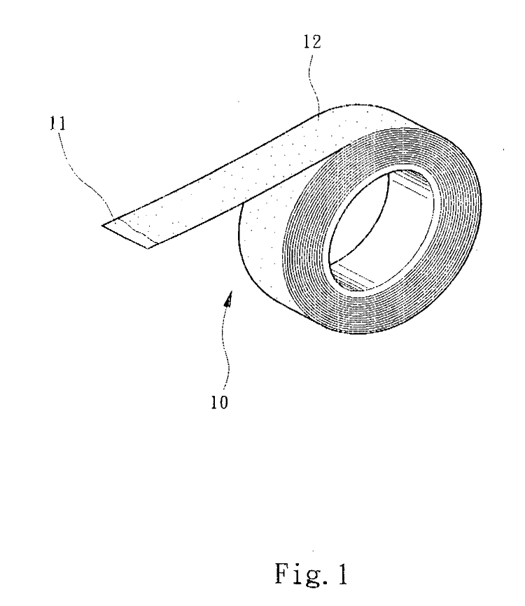

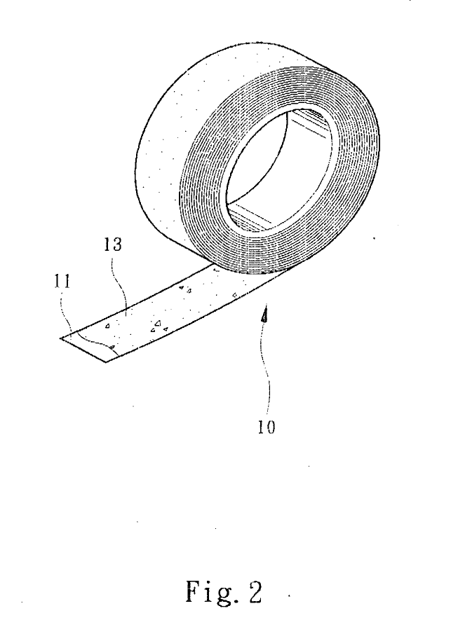

Please refer to FIGS. 1 and 2. The tape-type magnet 10 of the present invention includes a strap-shaped or tape-shaped soft magnetized substrate 11 with a thickness within 0.1 mm˜0.4 mm. The substrate 11 has a releasing agent layer 12 laid on an outer face of the substrate 11 and an adhesive layer 13 bonded with an inner face of the substrate 11. The substrate 11 is wound on a reel.

In a preferred embodiment, the substrate 11 is a thin sheet made of a mixture of a magnetizable material and plastic or rubber material. In a production line, the thin substrate is magnetized. The releasing agent layer 12 is laid on the upper face of the substrate and the adhesive layer 13 (such as pressure-sensitive adhesive) is laid on the lower face of the substrate. Then the substrate is wound by an automatic machine with the adhesive layer 13 facing inward and the releasing agent layer 12 facing outward. The releasing agent layer 12 serves to isolate the adhesive layers 13 of the wound substrate 11 from each other, whereby a user can easily tear the substrate apart.

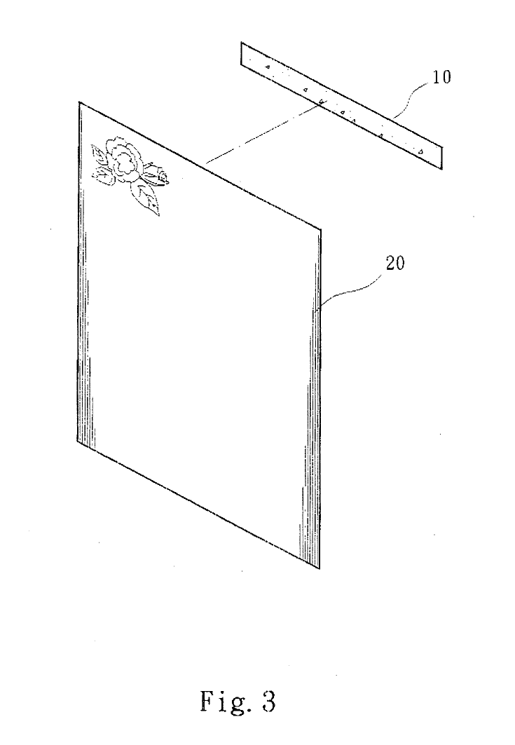

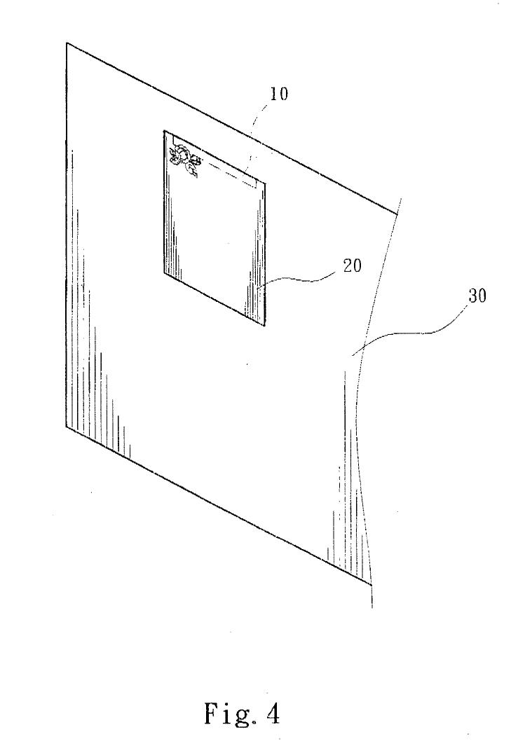

Referring to FIGS. 3 and 4, the outer end of the wound tape-type magnet 10 can be unwound and cut off into a segment. Then the segment can be adhered to a predetermined position of back face of an article 20. Than the article 20 with the tape-type magnet 10 can fixedly attract and attach to a magnetically attractable wall face or aboard face 30 by means of the magnetic attraction of the tape-type magnet 10. Alternatively, the back face of the article 20 can be a magnetically attractable face. The magnet 10 is previously adhered to the wall face or board face 30 via the adhesive layer 13. Then the article 20 can be directly attracted and attached to the wall face or board face 30 such as a bulletin board by means of the magnet 10.

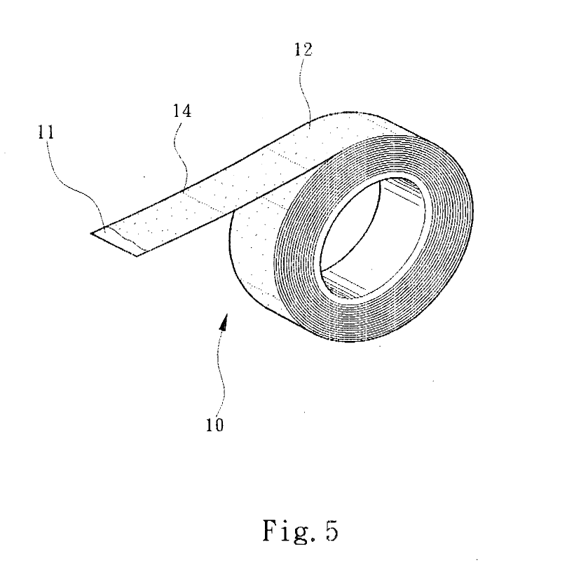

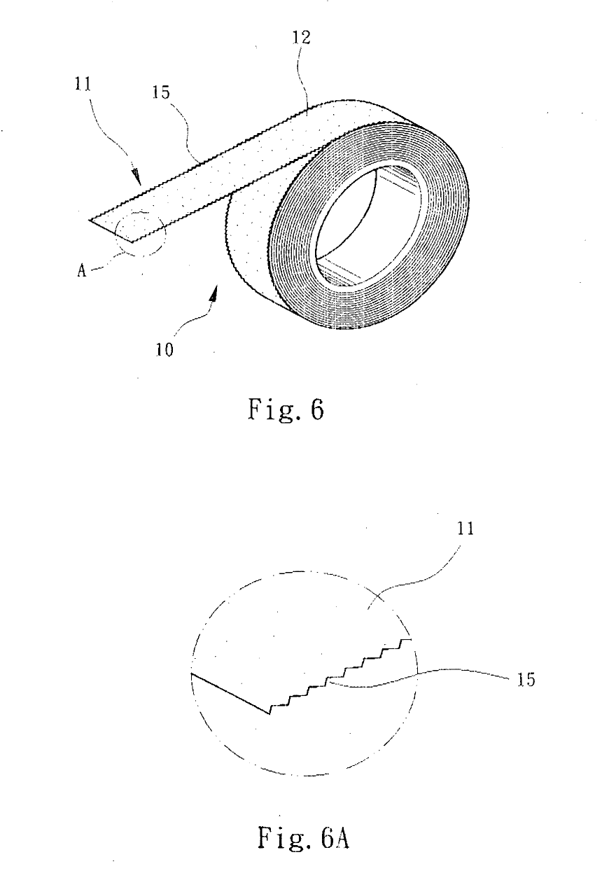

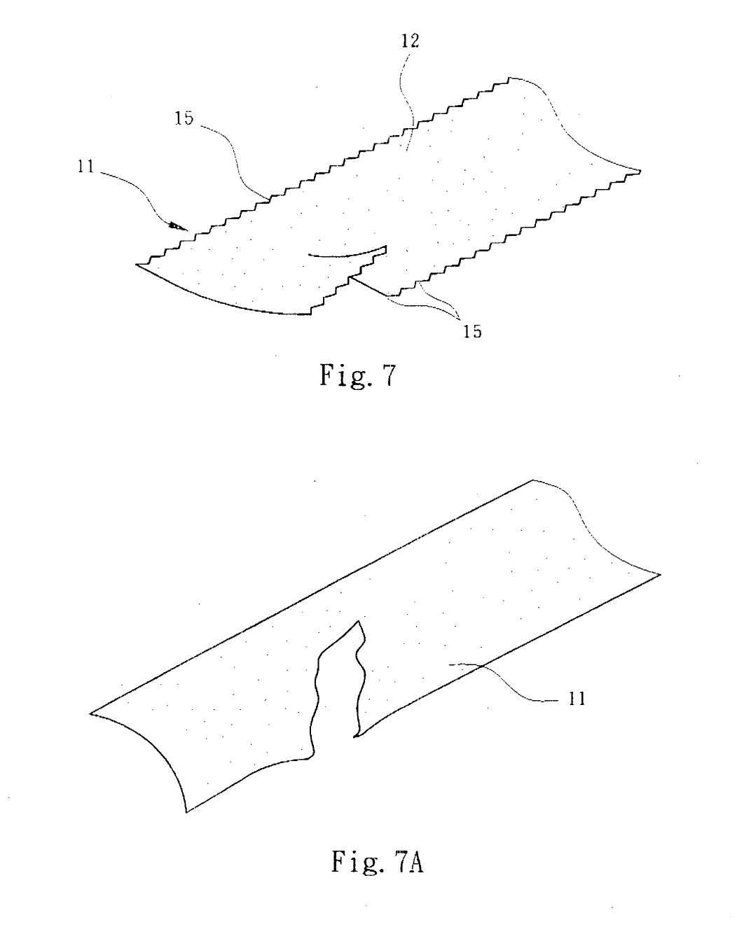

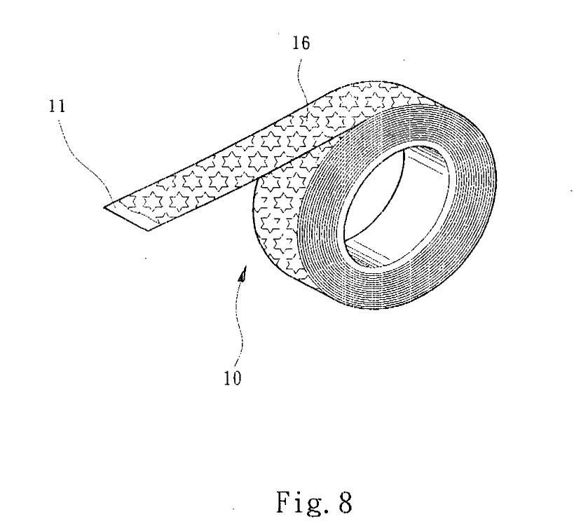

FIG. 5 shows another embodiment of the present invention. The strap-shaped or tape-shaped soft magnetized substrate 11 is formed with tearing lines 14 with a predetermined length. FIGS. 6 and 6A show still another embodiment of thee present invention. At least one side of the substrate 11 is formed wish continuous fine teeth 15. In use, a user can directly tear off a segment of the substrate with hands without using any cutting tool as shown in FIG. 7. The tearing line 14 can be a linear groove, a dotted line of recesses or a dotted line of fine orifices. In addition, as shown in FIG. 8, the substrate 11 is embossed with characters, stripes or FIG. 16 as trademarks or decorative figures.

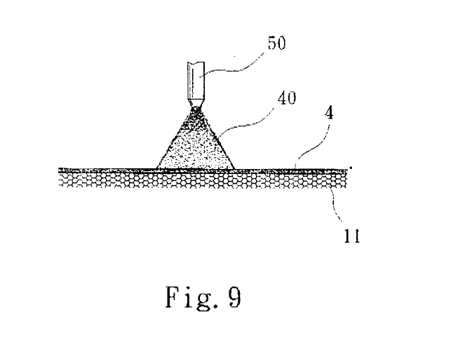

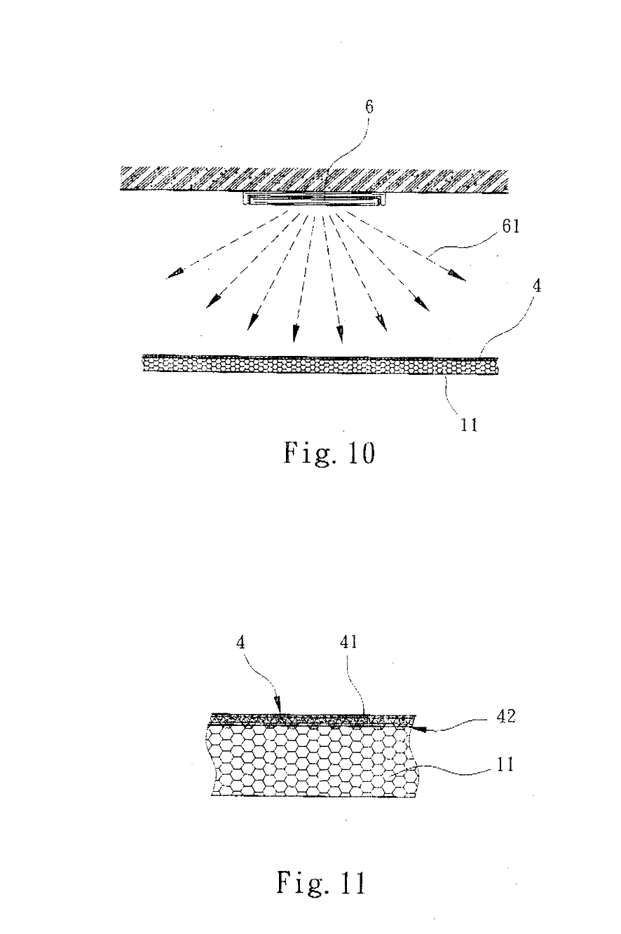

FIGS. 9 to 11 show a method for coloring a surface of a tape-type magnet, including steps of:
1. using a blending apparatus to mix and bond multifunction nitroacrylic acid, acrylic resin, organic solvent, color and paint additive (such as golden foil chips) with each other to form a paint 40 (which can be UV paint);
2. using a spraying apparatus 50 to spray the paint 40 onto the surface of the tape-type magnet 11 up to a predetermined thickness (about 0.01 mm) to form a paint layer 4 as shown in FIG. 9; and
3. using an ultraviolet ray source 6 to project ultraviolet ray 61 onto the paint layer 4 for a certain time to form a microcrystalline gum layer 41 (as shown in FIGS. 10 and 11), a crystalline bonding texture 42 being formed between the microcrystalline gum layer 41 and the surface of the soft magnetized substrate 11, that is, the microcrystalline gum layer 41 and the crystal of the magnetic layer of the substrate 11 being tightly inlaid in and bonded with each other, whereby the paint layer 4 serves as a protective layer which is smooth, antiwear and uneasy to peel off and crack.

In an alternative embodiment of the present invention, in step 1, a lubricant (not shown) is added into the paint. When spraying the paint 40 onto the surface of the soft magnetized substrate 11, a microcrystalline isolating effect is achieved to prevent alien impurities from infiltrating into and bonding with the paint layer 4.

In still another alternative embodiment in step 1, an additive (such as golden foil chips) can be added into the paint 40. Accordingly, the paint layer 4 sprayed on the surface of the substrate 11 can have special bright spots or a fogged texture for achieving a special visual effect.

Referring to FIG. 11, the crystalline bonding texture 42 is formed between the microcrystalline gum layer 41 and the magnetic layer of the substrate 11. Therefore, the paint layer 4 is tightly inlaid in and bonded with the magnetic layer of the substrate 11 via the crystalline bonding texture 42. Accordingly, the paint layer 4 is antiwear and uneasy to peel off and crack. In addition, the paint layer 4 is not subject to contamination of dust, fingerprint, etc.

Moreover, as shown in FIG. 11, the color is distributed over the microcrystalline gum layer 41 and more stably associated with the soft magnetized substrate 11. The soft magnetized substrate 11 can have different special color layouts without easy peeling in use. Therefore, the tape-type magnet can have better appearance than the conventional magnet.

One or more segment of the tape-shaped substrate 11 can be adhered to the back face of an article 20. Then the article 20 can conveniently attract and attach to a magnetically attractable wall face or board face 30 as necessary. Therefore, the application range of the magnet 10 is widened.

The above embodiments are only used to illustrate the present invention, not intended to limit the scope thereof. Many modifications of the above embodiments can be made without departing from the spirit of the present invention.

What is claimed is:

1. A tape-type magnet comprising a strap-shaped or tape-shaped soft magnetized substrate with a thickness within 0.1 mm˜0.4 mm, the substrate having a releasing agent layer laid on an outer face of the substrate and an adhesive layer bonded with an inner face of the substrate, the substrate being wound, whereby at least one end of the wound substrate can be unwound and cut off into a segment to adhere to or attract a surface of an article, whereby the article with the tape-type magnet can fixedly attract or adhere to a wall face or a board face, the releasing agent layer serving to isolate the adhesive layers of the wound substrate from each other.

2. The tape-type magnet as claimed in claim 1, wherein the adhesive layer is a pressure-sensitive adhesive layer.

3. The tape-type magnet as claimed in claim 1, wherein the strap-shaped or tape-shaped soft magnetized substrate is formed with tearing lines with a predetermined length.

4. The tape-type magnet as claimed in claim 3, wherein the tearing line is a linear groove.

5. The tape-type magnet as claimed in claim 3, wherein the tearing line is a dotted line of recesses.

6. The tape-type magnet as claimed in claim 3, wherein the tearing line is a dotted line of fine orifices.

7. The tape-type magnet as claimed in claim 1, wherein at least one side of the substrate is formed with continuous fine teeth.

8. The tape-type magnet as claimed in claim 2, wherein at least one side of the substrate is formed with continuous fine teeth.

9. The tape-type magnet as claimed in claim 3, wherein at least one side of the substrate is formed With continuous fine teeth.

10. The tape-type magnet as claimed in claim 1, wherein a paint layer is laid on at least one face of the substrate, the paint layer forming a microcrystalline layer and a crystalline bonding texture being formed between the microcrystalline layer and the substrate.

11. The tape-type magnet as claimed in claim 2, wherein a paint layer is laid on at least one face of the substrate, the paint layer forming a microcrystalline layer and a crystalline bonding texture being formed between the microcrystalline layer and the substrate.

12. The tape-type magnet as claimed in claim 3, wherein a paint layer is laid on at least one face of the substrate, the paint layer forming a microcrystalline layer and a crystalline bonding texture being formed between the microcrystalline layer and the substrate.

13. The tape-type magnet as claimed in claim 4, wherein a paint layer is laid on at least one face of the substrate, the paint layer forming a microcrystalline layer and a crystalline bonding texture being formed between the microcrystalline layer and the substrate.

14. The tape-type magnet as claimed in claim 5, where in a paint layer is laid on at least one face of the substrate, the paint layer forming a microcrystalline layer and a crystal line bonding texture being formed between the microcrystalline layer and the substrate.

15. The tape-type magnet as claimed in claim 6, wherein a paint layer is laid on at least one face of the substrate, the paint layer forming a microcrystalline layer and a crystalline bonding texture being formed between the microcrystalline layer and the substrate.

16. The tape-type magnet as claimed in claim 7, wherein a paint layer is laid on at least one face of the substrate, the paint layer forming a microcrystalline layer and a crystalline bonding texture being formed between the microcrystalline layer and the substrate.

17. The tape-type magnet as claimed in claim 8, wherein a paint layer is laid on at least one face of the substrate, the paint layer forming a microcrystalline layer and a crystalline bonding texture being formed between the microcrystalline layer and the substrate.

18. The tape-type magnet as claimed in claim 9, wherein a paint layer is laid on at least one face of the substrate, the paint layer forming a microcrystalline layer and a crystalline bonding texture being formed between the microcrystalline layer and the substrate.

19. The tape-type magnet as claimed in claim 1, wherein a surface of the soft magnetized substrate is embossed with characters, stripes or figures.

20. The tape-type magnet as claimed in claim 2, wherein a surface of the soft magnetized substrate is embossed with characters, stripes or figures.

21. The tape-type magnet as claimed in claim 3, wherein a surface of the soft magnetized substrate is embossed with characters, stripes or figures.

22. The tape-type magnet as claimed in claim 4, wherein a surface of the soft magnetized substrate is embossed with characters, stripes or figures.

23. The tape-type magnet as claimed in claim 5, wherein a surface of the soft magnetized substrate is embossed with characters, stripes or figures.

24. The tape-type magnet as claimed in claim 6, wherein a surface of the soft magnetized substrate is embossed with characters, stripes or figures.

25. The tape-type magnet as claimed in claim 7, wherein a surface of the soft magnetized substrate is embossed with characters, stripes or figures.

26. The tape-type magnet as claimed in claim 8, wherein a surface of the soft magnetized substrate is embossed with characters, stripes or figures.

27. The tape-type magnet as claimed in claim 9, wherein a surface of the soft magnetized substrate is embossed with characters, stripes or figures.

28. The tape-type magnet as claimed in claim 10, wherein a surface of the soft magnetized substrate its embossed with characters, stripes or figures.

29. The tape-type magnet as claimed in claim 11, wherein a surface of the soft magnetized substrate is embossed with characters, stripes or figures.

30. The tape-type magnet as claimed in claim 12, wherein a surface of the soft magnetized substrate is embossed with characters, stripes or figures.

31. The tape-type magnet as claimed in claim 13, wherein a surface of the soft magnetized substrate is embossed with characters, stripes or figures.

32. The tape-type magnet as claimed in claim 14, wherein a surface of the soft magnetized substrate is embossed with characters, stripes or figures.

33. The tape-type magnet as claimed in claim 15, wherein a surface of the soft magnetized substrate is embossed with characters, stripes or figures.

34. The tape-type magnet as claimed in claim 16, wherein a surface of the soft magnetized substrate is embossed with characters, stripes or figures.

35. The tape-type magnet as claimed in claim 17, wherein a surface of the soft magnetized substrate is embossed with characters, stripes or figures.

36. The tape-type magnet as claimed in claim 18, wherein a surface of the soft magnetized substrate is embossed with characters, stripes or figures.
